(19) United States
(12) Patent Application Publication
(10) Pub. No.: US 2025/0003747 A1
(43) Pub. Date: Jan. 2, 2025

(54) DIGITAL ANGLE GAUGE WITH MULTIPLE LIGHT LEVEL INDICATORS

(71) Applicant: Klein Tools, Inc., Lincolnshire, IL (US)

(72) Inventors: Catalin Virgil Captarencu, Barrington, IL (US); David Lightman, Mundelein, IL (US)

(73) Assignee: Klein Tools, Inc., Lincolnshire, IL (US)

(21) Appl. No.: 18/758,518

(22) Filed: Jun. 28, 2024

Related U.S. Application Data
(60) Provisional application No. 63/524,543, filed on Jun. 30, 2023.

(51) Int. Cl. G01C 9/06

(52) U.S. Cl. CPC G01C 9/06; G01C 2009/066

(57) ABSTRACT

A digital angle gauge includes a housing body. The housing body includes a first surface having a first light opening, a second surface, opposing the first surface, having a second light opening, and a third surface, adjacent the first surface and the second surface, having a third light opening. The digital angle gauge includes an orientation sensor configured to measure an orientation of the housing body with respect to gravity. The digital angle gauge includes a light source, wherein the light source emits light based on the measured orientation of the housing body. The digital angle gauge includes a light guide, disposed in the housing body, directing the light from light source to the first light opening, the second light opening, and the third light opening.

### CROSS-REFERENCE TO RELATED APPLICATIONS

This patent application claims priority of U.S. Provisional Patent Application No. 63/524,543 filed on Jun. 30, 2023, the entire contents of which is herein incorporated by reference.

### BACKGROUND OF THE DISCLOSURE

The present disclosure relates to angle gauges and, more specifically, to digital angle gauges with multiple light level indicators. Conventional angle gauges, also known as levels, traditionally use one or more vials containing liquid and a gas bubble. A user may align the bubble at the center of the vial to orient the angle finder (e.g., level) in a level position. Digital angle finders often have screens that display the angle of the digital angle finder in relation to that of gravity. Depending on the orientation of such a digital angle finder, it may be difficult for a user to see the screen and determine when the digital angle finder is level. It is desirable to provide a digital angle finder to overcome this issue, improving ease of use and allowing a user to read the output of a digital angle finder quickly and easily.

### BRIEF SUMMARY OF THE DISCLOSURE

In accordance with one feature of this disclosure, a digital angle gauge is provided. The digital angle gauge includes a housing body. The housing body includes a front surface having a first light opening and a second light opening, a rear surface, opposing the front surface, having a third light opening and a fourth light opening, a first side surface, adjacent the front surface and the rear surface, having a fifth light opening, and a second side surface, adjacent the front surface and the rear surface and opposing the first side surface, having a sixth light opening. The digital angle gauge includes an orientation sensor configured to measure an orientation of the housing body with respect to gravity. The digital angle gauge includes a printed circuit board disposed in the housing body and having a first light source and a second light source. The first light source and the second light source emit light based on the measured orientation of the housing body. The digital angle gauge includes a first light guide, disposed in the housing body, directing the light from the first light source to the first light opening, the third light opening, and the fifth light opening. The digital angle gauge includes a second light guide, disposed in the housing body, directing the light from the second light source to the second light opening, the fourth light opening, and the sixth light opening.

In one feature, the first source or the second source is a side emitting light emitting diode.

As one feature, the first light guide has a concave portion at least partially covering the first light source.

In another feature, the first light guide is of unitary construction.

According to one feature, the light guide is composed of silicone.

In yet a further feature, the light guide is composed of polycarbonate.

In one feature, the digital angle gauge includes a processor configured to determine, based on the orientation sensors measurement, a deviation of the digital level from a target orientation.

As another feature, the light source is a multicolor light emitting diode configured to emit green light, yellow light, or red light, and the light source emits, based on the deviation of the digital level from the target orientation, the green light, the yellow light, or the red light.

In one feature, the light source emits the green light based on determining that the deviation of the digital level from the target orientation is less than 0.2 degrees, the light source emits the yellow light based on determining that the deviation of the digital level from the target orientation is greater than 0.2 degrees and less than 5 degrees, and the light source emits the red light based on determining that the deviation of the digital level from the target orientation is greater than 5 degrees.

As one feature, the light source emits the light based on determining that the deviation of the digital level from the target orientation is less than 0.1 degrees.

In another feature, the digital angle gauge includes a user input to set the target orientation.

According to one feature, at least a portion of the front surface or the first side surface separates the first light opening from the fifth light opening.

In accordance with one feature of this disclosure, a digital angle gauge is provided. The digital angle gauge includes a housing body. The housing body includes a first surface having a first light opening, a second surface, opposing the first surface, having a second light opening, and a third surface, adjacent the first surface and the second surface, having a third light opening. The digital angle gauge includes an orientation sensor configured to measure an orientation of the housing body with respect to gravity. The digital angle gauge includes a light source, wherein the light source emits light based on the measured orientation of the housing body. The digital angle gauge includes a light guide, disposed in the housing body, directing the light from light source to the first light opening, the second light opening, and the third light opening.

In one feature, the first surface has a fourth light opening, the second surface has a fifth light opening, and the third surface has a sixth light opening. The digital level includes a second light source, and the second light source emits light based on the measured orientation of the housing body. The digital level includes a second light guide, disposed in the housing body, directing the light from second light source to the fourth light opening, the fifth light opening, and the sixth light opening.

As one feature, the digital angle finder includes a processor configured to determine, based on the orientation sensors measurement, a deviation of the digital level from a target orientation. The light source emits the light based on determining that the deviation of the digital level from the target orientation is less than 0.1 degrees.

In another feature, the first light guide is of unitary construction.

In accordance with one feature of this disclosure, a digital angle gauge is provided and includes a housing body. The housing body includes a front surface having a first light opening, a rear surface, opposing the first surface, having a second light opening, a corner surface, adjacent the front surface and the rear surface, having a third light opening, and a base surface. The digital angle gauge includes an orientation sensor configured to measure an orientation of the base surface with respect to gravity. The digital angle gauge includes a light source. The light source emits light based on the measured orientation of the base surface. The digital angle gauge includes a light guide, disposed in the housing body, directing the light from the light source to the first light opening, the second light opening, and the third light opening.

In one feature, the front surface has a fourth light opening, the rear surface has a fifth light opening, and the corner surface has a sixth light opening. The digital level includes a second light source, wherein the second light source emits light based on the measured orientation of the base surface. The digital level includes a second light guide, disposed in the housing body, directing the light from second light source to the fourth light opening, the fifth light opening, and the sixth light opening.

As one feature, the digital level includes a processor configured to determine, based on the orientation sensors measurement, a deviation of the digital level from a target orientation. The light source emits the light based on determining that the deviation of the digital level from the target orientation is less than 0.1 degrees.

In another feature, the first light guide is of unitary construction.

### BRIEF DESCRIPTION OF THE DRAWINGS

FIG. 1 is a perspective view of a digital angle finder with multiple level indicators.

FIG. 2 is a front view of the digital angle finder of FIG. 1.

FIG. 3 is a rear view of the digital angle finder of FIG. 1.

FIG. 4 is a top view of the digital angle finder of FIG. 1.

FIG. 5 is a side view of the digital angle finder of FIG. 1.

FIG. 6 is a cross-section view of the digital angle finder taken about line 6-6 of FIG. 4 showing a printed circuit board and light guides.

FIG. 7 is a similar cross-section view similar to FIG. 6, but with the printed circuit board removed.

FIG. 8A is an exploded perspective view of the digital angle finder of FIG. 1.

FIG. 8B is another exploded perspective view of the digital angle finder of FIG. 1.

FIG. 9A is a perspective view of a light guide for the digital angle finder of FIG. 1.

FIG. 9B is another perspective view of the light guide of FIG. 9A.

FIG. 9C is another perspective view of the light guide of FIG. 9A.

FIG. 9D is a side view of the light guide of FIG. 9A.

### DETAILED DESCRIPTION OF PREFERRED EMBODIMENTS

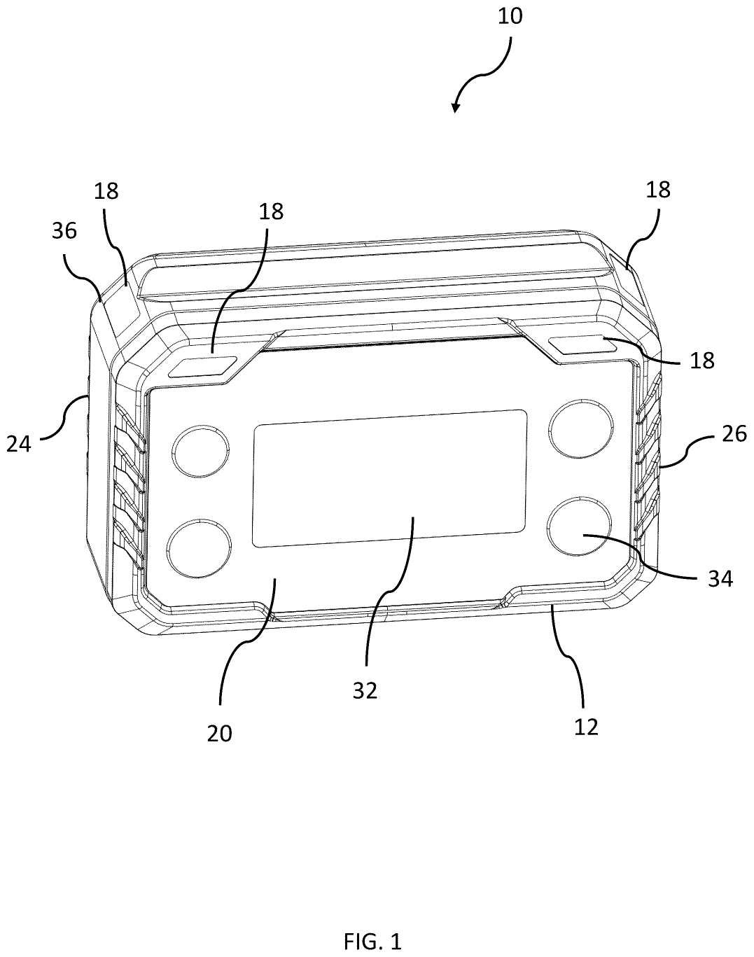

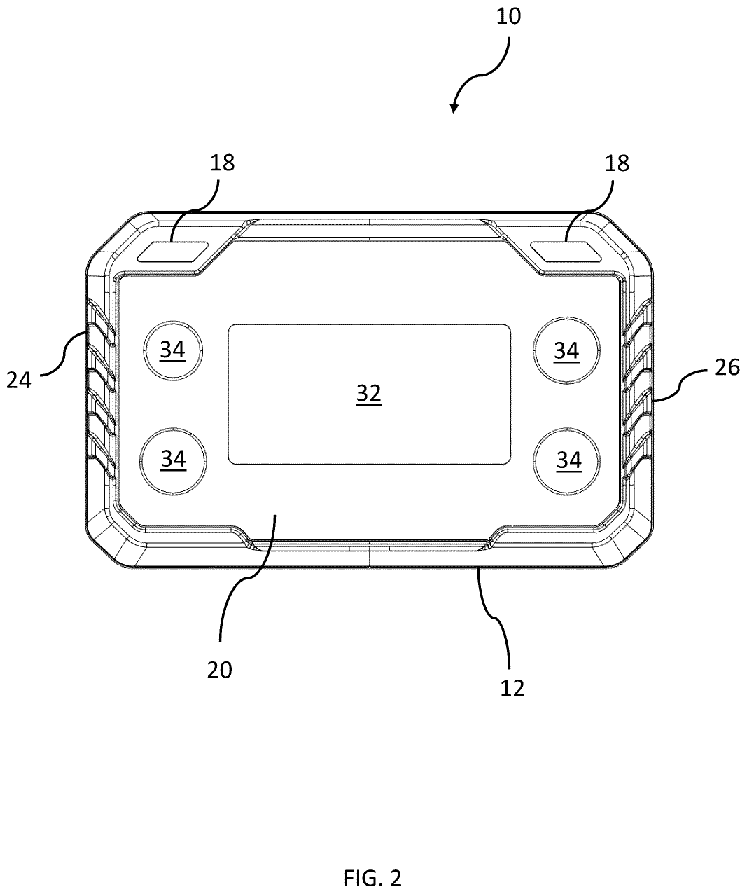

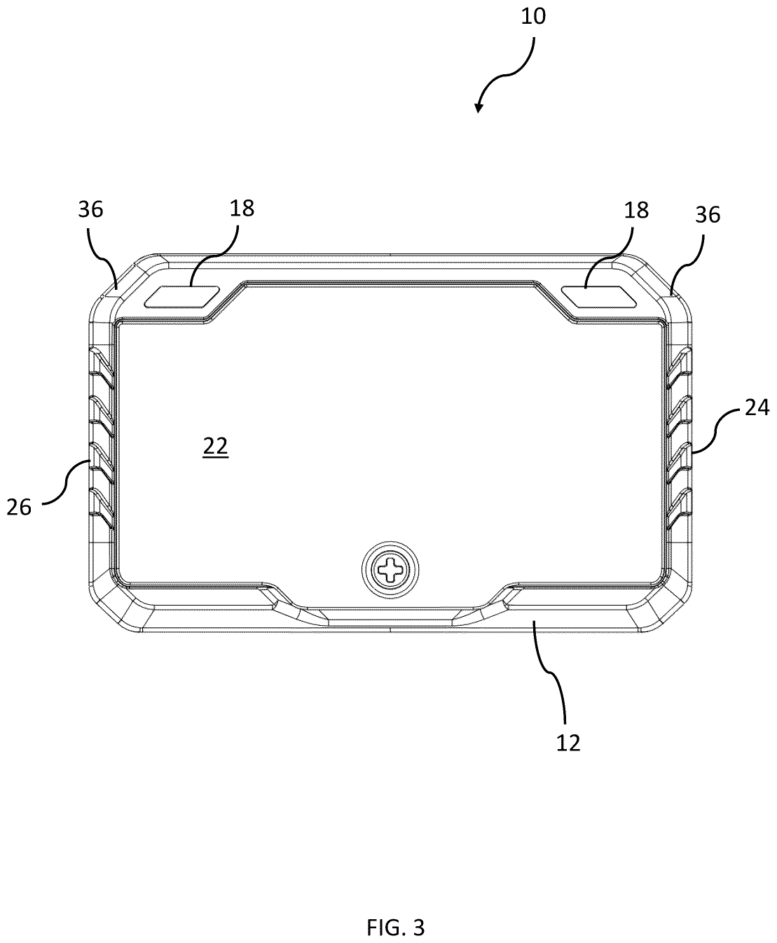

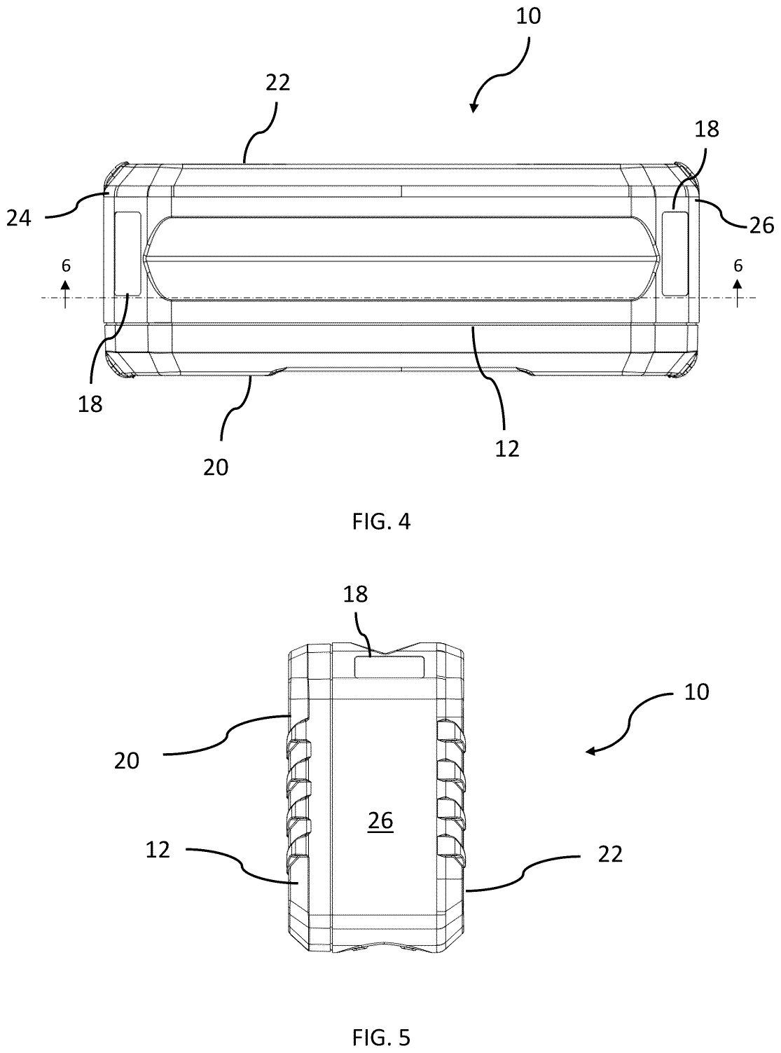

As best seen in FIGS. 1-5, a digital angle gauge 10 is provided. In the illustrated and preferred embodiment, the digital angle gauge 10 includes a housing body 12 and an orientation sensor to determine the orientation of the housing body 12 relative to gravity. The digital angle gauge 10 includes at least one light source 14. In the illustrated and preferred embodiment, the light source 14 provides information to the user regarding the orientation of the housing body 12. The digital angle gauge 10 includes at least one light guide 16 disposed in the housing body 12 to direct light emitted by the light source 14 to multiple light openings 18 in the housing body 12. In the illustrated and preferred embodiment, the housing body 12 has multiple light openings 18 on different sides of the housing body 12 to allow for a user to see light emitted by the light source 14 from multiple angles or positions.

In the illustrated and preferred embodiment, the housing body 12 includes a front surface 20, a rear surface 22, a first side surface 24, a second side surface 26, a top surface 28, and a bottom surface 30. In the illustrated and preferred embodiment, the front surface 20 (e.g., first surface, front) includes a display 32 and user inputs 34 (e.g., buttons) for interacting (e.g., user interaction) with the digital angle gauge 10. In the illustrated and preferred embodiment, the rear surface 22 (e.g., second surface, back surface, back) is opposite the front surface 20 and includes a power supply cover (e.g., battery cover). In the illustrated and preferred embodiment, the housing body 12 includes a pair of opposed side surfaces (e.g., first side surface 24, second side surface 26) adjacent to the front surface 20 and the rear surface 22. In the illustrated and preferred embodiment, the bottom surface 30 is a generally planar surface adjacent and generally perpendicular to the front surface 20 and the rear surface 22. The top surface 28 is adjacent to the front surface 20, the rear surface 22, the first side surface 24, and the second side surface 26 and opposite the bottom surface 30. In the illustrated and preferred embodiment, the top surface 28 and bottom surface 30 may be placed against a surface (e.g., by a user) to find the angle thereof by determining the orientation of the digital angle finder 10. While the top surface 28 and bottom surface 30 may typically be used, any of the first side surface 24, second side surface 26, the front surface 20, and the rear surface 22 may also be used to determine the orientation (e.g., angle) of a surface.

In the illustrated and preferred embodiment, the digital angle gauge 10 includes six light openings 18. In the illustrated and preferred embodiment, the light openings 18 include an opening passing through the associated surface to allow light to pass therethrough. The front surface 20 includes a pair of light openings 18, having one in each of the top corners. The rear surface 22 includes another pair of light openings 18 (e.g., one in each top corner), opposite the light openings 18 of the front surface 20. The side surfaces 24, 26 each have a single light opening 18, each adjacent one of the light openings 18 of the front surface 20 and one of the light openings 18 of the rear surface 22. In the illustrated and preferred embodiment, the first side surface 24 and the second side surface 26 each include a corner portion 36 (e.g., corner surface) angled inwards relative to the rest of the first side surface 24 or the second side surface 26 (e.g., angled towards the top surface 28). In the illustrated and preferred embodiment, the light openings 18 are disposed on (e.g., pass through) the corner portion 36 of the first side surface 24 and the second side surface 26.

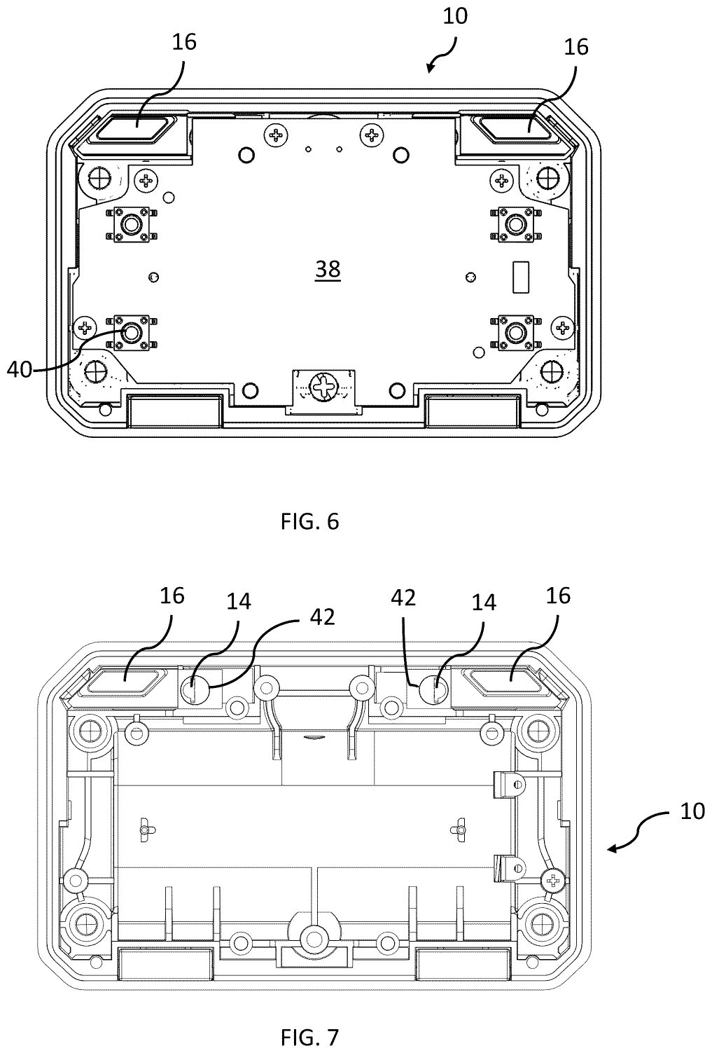

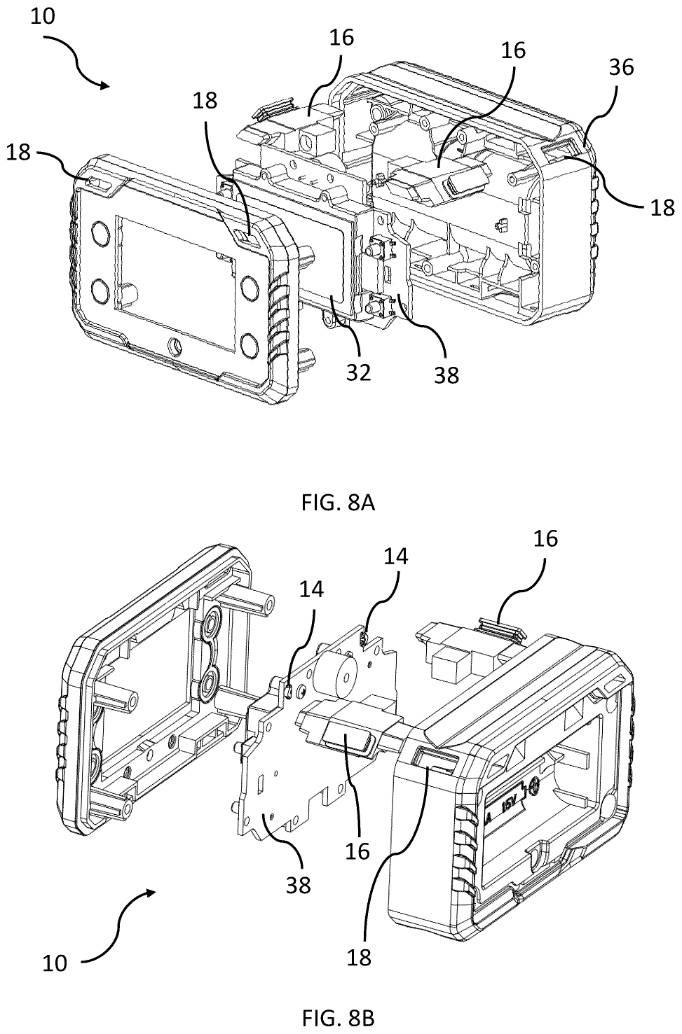

As best shown in FIGS. 6, 8A, and 8B, the digital angle gauge 10 includes a printed circuit board disposed in the housing body 12. In the illustrated and preferred embodiment, the printed circuit board 38 includes (e.g., is attached to or in electric communication with) a processor, the display 32, one or more switches 40 associated with the user inputs 34, an orientation sensor, and a pair of light sources 14 shown in the form of side firing light emitting diodes (LEDs). In the illustrated and preferred embodiment, the display 32 is shown in the form of an LCD. The display 32 may, in some examples, be used as the primary source of visual signals to a user of the digital angle gauge 10. The display 32 may show the orientation of the digital angle gauge 10 to the user and may be used, along with the user inputs 34, for user I/O (e.g., input and output for a user to change settings or otherwise interact with the digital angle gauge 10).

In the illustrated and preferred embodiment, the orientation sensor measures the orientation of the orientation sensor with respect to gravity. Orientation data measured by the orientation sensor is used to determine the orientation of the digital angle gauge 10. In some embodiments, the orientation data is sent to the processor to determine the orientation of the angle gauge 10. In the illustrated and preferred embodiment, the orientation sensor determines the orientation of at least one of the front surface 20, rear surface 22, first side surface 24, second side surface 26, top surface 28, and/or bottom surface 30. A user may position one of the front surface 20, rear surface 22, first side surface 24, second side surface 26, top surface 28, and/or bottom surface 30 next to a surface to be measured. In the illustrated and preferred embodiment, the measured orientation of the surface to be measured (e.g., the surface abutting one of the front surface 20, rear surface 22, first side surface 24, second side surface 26, top surface 28, and/or bottom surface 30) may be displayed on the display 32. In some examples, the processor determines a deviation of the orientation of the digital angle gauge 10 from a target orientation. In some embodiments, the display 32 may show a deviation of the measured orientation from a target orientation. In the illustrated and preferred example, the target orientation is a preprogrammed orientation selected from a plurality of orientation options or the target orientation is a user input orientation.

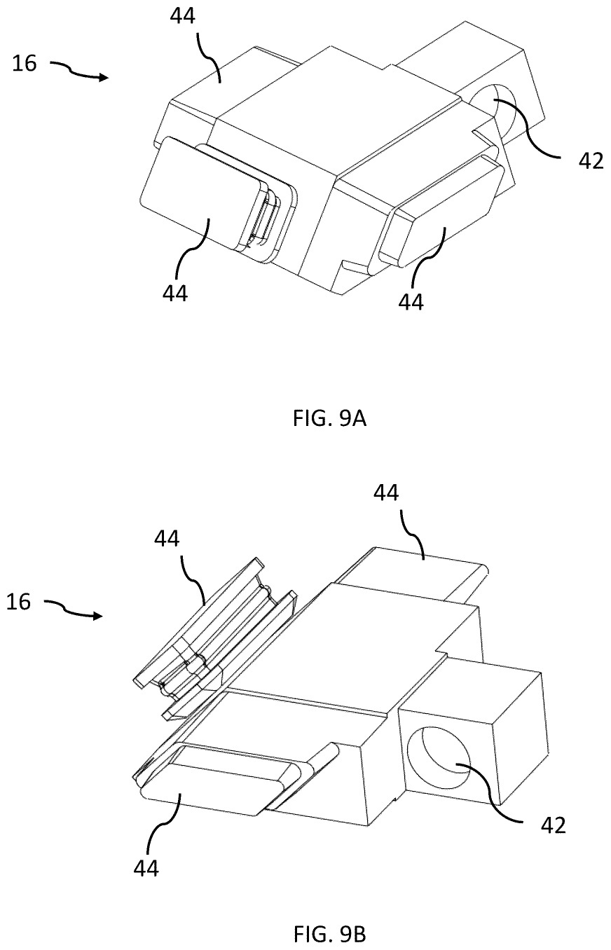

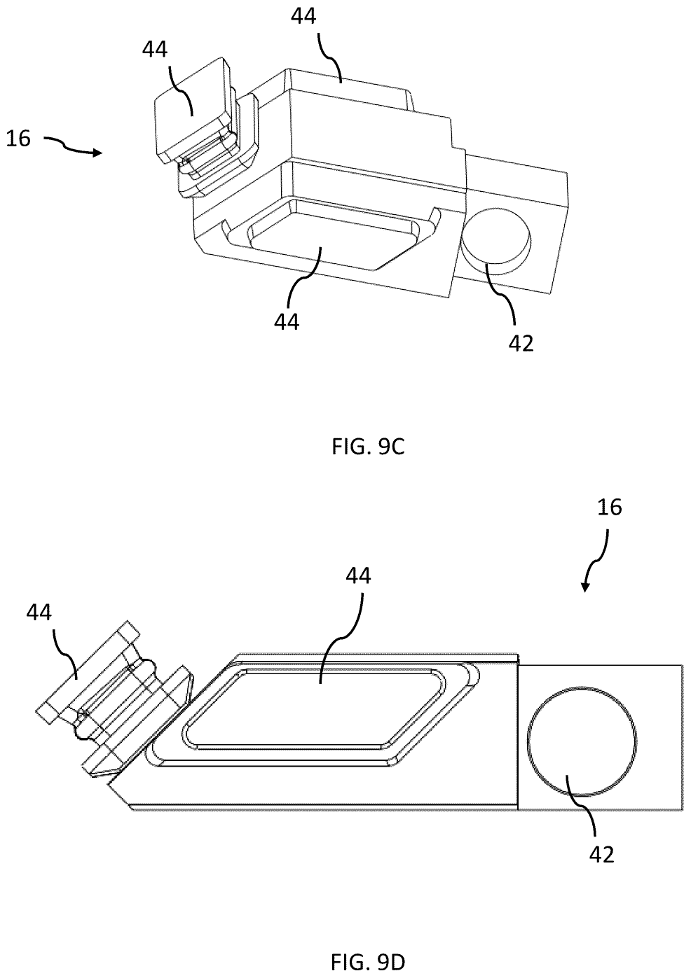

In the illustrated and preferred embodiment, the digital angle gauge 10 has a pair of light guides 16 (e.g., light pipes). Each light guide 16 directs light (e.g., provides optical communication) between the light sources 14 and one or more of the light openings 18. In the illustrated and preferred embodiment, each light guide 16 directs light from one light source 14 to three light openings 18. As best shown in FIGS. 9A-9D, the light guide 16 includes a concave portion 42 (e.g., opening, cutout) to at least partially cover or surround an associated light source 14. In the illustrated and preferred embodiment, the light guide 16 has three light guide extension portions 44 protruding from the light guide 16. In the illustrated and preferred embodiment, a first extension portion 44 protrudes from a side of the light guide 16 opposite the concave portion 42 and two extensions portions 44 protrude, opposite each other, in between the first extension portion 44 and the concave portion 42. In some examples, the light guide 16 is of unitary construction with the entire light guide 16 and associated extension portions 44 formed of a single piece of material. In some examples, the light guide 16 is of multi-piece construction. Multi-piece construction of the light guide 16 may, in some examples, decrease the manufacturing difficulty of installing the light guide 16 into the housing body 12. For example, one or more of the extension portions 44 may be formed of a different piece of material than the rest of the light guide 16. In the illustrated and preferred embodiment, the light guide 16 is shaped to at least partially conform to the interior of the housing body 12. The extension portions 44 are shaped to each correspond to an associated light opening 18. In the illustrated and preferred embodiment, the light guide 16 is formed of silicone or polycarbonate material. Other transparent or translucent materials that direct light may also be used.

In the illustrated and preferred embodiment, the concave portion 42 of the light guide 16 at least partially covers an associated light source 14 and directs light from the light source 14, through the extension portions 44, and out the light openings 18. In the illustrated and preferred embodiment, the concave portion 42 covers the side firing LED light source 14 located at the top corner of the PCB (e.g., as shown in FIG. 14). FIG. 6 shows a cross-section of the digital angle gauge 10 taken along line 6-6. FIG. 7 shows a similar cross-section with the PCB removed, showing the light sources 14 protruding (e.g., from the hidden PCB) into the concave portion 42.

In the illustrated and preferred embodiment, the light guide 16 enables a single light source 14 to output light to multiple (e.g., three in the illustrated and preferred embodiment) light openings 18. In the illustrated and preferred embodiment, the light openings 18 associated with a single light source 14 and light guide 16 are located on three different sides of the housing body 12. For example, the light guide 16 directs light from a single light source 14 to light openings 18 in the front surface 20, back surface 22, and first side surface 24 (e.g., corner portion 36).

In the illustrated and preferred embodiment, the light source 14 are used to inform a user of the measured orientation of the digital angle gauge 10 without use of the display 32, in addition to the display 32, and/or when the digital angle gauge 10 is in an orientation where the user cannot see the display 32. In the illustrated and preferred embodiment, the light source 14 is a multicolored light source capable of outputting light of varying colors. In the illustrated and preferred embodiment, the light source 14 is a tri-color LED light source 14 capable of emitting green, yellow, or red light. In one example mode of operation, the digital angle gauge 10 (e.g., the orientation and the processor) determines the orientation of the digital angle gauge 10 and uses the light source 14 to indicate, to the user, when the digital angle gauge 10 is level. In such an example, the light source 14 will emit green light when the digital angle gauge 10 is less than 0.1 degrees from the target orientation (e.g., target orientation is level or 0 degrees in this example). The light source 14 may emit a red light or may be turned off when the digital angle gauge 10 is greater than 0.1 degrees from the target orientation.

In another example mode, the light source 14 emits green light based on determining that the orientation of the digital level 10 is less than 0.2 degrees from a target orientation. The light source 14 emits yellow light based on determining that the orientation of the digital level 10 is greater than 0.2 degrees and less than 5 degrees from the target orientation. In some examples the light source may intermittently flash the yellow light on and off. Finally, the light source 14 may emit red light based on determining orientation of the digital level is greater than 5 degrees from the target orientation. In some examples, the target orientation is 0 degrees (e.g., level with gravity). In other examples, the target orientation may be set by the user. In some examples, digital angle finder 10 includes preprogrammed target orientations (e.g., 0 degrees, 10 degrees, 22.5 degrees, 30 degrees, 45 degrees, 90 degrees, etc.) that may be selected by the user (e.g., by use of the display 32 and user inputs 34).

Preferred embodiments of the inventive concepts are described herein, including the best mode known to the inventor(s) for carrying out the inventive concepts. Variations of those preferred embodiments will become apparent to those of ordinary skill in the art upon reading the foregoing description. The inventor(s) expect skilled artisans to employ such variations as appropriate, and the inventor(s) intend that the inventive concepts can be practiced otherwise than as specifically described herein. Accordingly, the inventive concepts disclosed herein include all modifications and equivalents of the subject matter recited in the claims appended hereto as permitted by applicable law. Moreover, any combination of the above-described elements and features in all possible variations thereof is encompassed by the inventive concepts unless otherwise indicated herein or otherwise clearly contradicted by context. Further in this regard, while highly preferred forms of the digital angle gauge are shown in the figures, it should be understood that this disclosure anticipates variations in the specific details of each of the disclosed components and features of the material dispenser and that no limitation to a specific form, configuration, or detail is intended unless expressly and specifically recited in an appended claim.

For example, while specific and preferred forms have been shown for the locations of light openings 18, other locations may be used. For example, while a light opening 18 is shown on the corner portion 36 of the first side surface 24 and the second side surface 26, in some examples the first side surface 24 and the second side surface 26 may not include angled corner portions 36 and the light openings 18 may be positioned on the first side surface 24 or the second side surface 26. In some examples, a light opening 18 may be located in the top surface 28.

As another example, while the digital angle gauge 10 is shown having a light source 14 with an associated light guide 16 and light openings 18 in each of the top corners of the digital angle gauge 10, some examples may include the light source 14, light guide, and light openings 18 in the bottom corners of the digital angle gauge 10. Some examples may include the light source 14, light guide, and light openings 18 in the middle of the digital angle gauge 10 (e.g., middle of either side of the digital angle gauge).

As yet another example, while the light guides 16 are each shown having three extension portions 44 directing light to three light openings 18, other numbers of extension portions 44 and light openings 18 may be used. In some examples, the light guide 16 may have two extension portions 44 directing light to two light openings 18. In such examples the two light openings 18 associated with a single light guide 16 may be in the front surface 20 and the rear surface 22. In some examples the two light openings 18 associated with a single light guide 16 may be in the front surface 20 and the first side surface 24 or second side surface 26. In some examples the two light openings 18 associated with a single light guide 16 may be in the rear surface 22 and the first side surface 24 or second side surface 26. In another example, the light guide 16 may have four or more extension portions 44 directing light four or more light openings 18. For example, guide 16 may have four extension portions 44 directing light to four light openings 18 (e.g., one light opening 18 in each of the front surface 20, rear surface 22, top surface 28, and first side surface 24 or second side surface 26).

As yet a further example, while the light source 14 is shown in the form of a tri-colored LED, other light sources 14 may be used. For example, the light source 14 may emit colors other than green, yellow, or red. In some examples the light source 14 may only emit white light. In such an example, the light source 14 may indicate the orientation of the digital angle gauge by using light patterns (e.g., flashing) instead of light color.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. The use of any and all examples, or exemplary language (e.g., “such as”) provided herein, is intended merely to better illuminate the inventive concepts disclosed herein and does not pose a limitation on the scope of any invention unless expressly claimed. No language in the specification should be construed as indicating any non-claimed element as essential to the practice of the inventive concepts disclosed herein.

What is claimed is:

1. A digital angle gauge comprising:
a housing body, comprising:
a front surface having a first light opening and a second light opening;
a rear surface, opposing the front surface, having a third light opening and a fourth light opening;
a first side surface, adjacent the front surface and the rear surface, having a fifth light opening; and
a second side surface, adjacent the front surface and the rear surface and opposing the first side surface, having a sixth light opening;
an orientation sensor configured to measure an orientation of the housing body with respect to gravity;
a printed circuit board disposed in the housing body and having a first light source and a second light source, wherein the first light source and the second light source emit light based on the measured orientation of the housing body;
a first light guide, disposed in the housing body, directing the light from the first light source to the first light opening, the third light opening, and the fifth light opening; and
a second light guide, disposed in the housing body, directing the light from the second light source to the second light opening, the fourth light opening, and the sixth light opening.

2. The digital level of claim 1, wherein the first source or the second source is a side emitting light emitting diode.

3. The digital level of claim 1, wherein the first light guide has a concave portion at least partially covering the first light source.

4. The digital level of claim 1, wherein the first light guide is of unitary construction.

5. The digital level of claim 1, wherein the light guide is composed of silicone.

6. The digital level of claim 1, wherein the light guide is composed of polycarbonate.

7. The digital level of claim 1, further comprising a processor configured to determine, based on the orientation sensors measurement, a deviation of the digital level from a target orientation.

8. The digital level of claim 7, wherein:
the light source is a multicolor light emitting diode configured to emit green light, yellow light, or red light; and
the light source emits, based on the deviation of the digital level from the target orientation, the green light, the yellow light, or the red light.

9. The digital level of claim 8, wherein:
the light source emits the green light based on determining that the deviation of the digital level from the target orientation is less than 0.2 degrees;
the light source emits the yellow light based on determining that the deviation of the digital level from the target orientation is greater than 0.2 degrees and less than 5 degrees; and
the light source emits the red light based on determining that the deviation of the digital level from the target orientation is greater than 5 degrees.

10. The digital level of claim 7, wherein the light source emits the light based on determining that the deviation of the digital level from the target orientation is less than 0.1 degrees.

11. The digital level of claim 7, further comprising a user input to set the target orientation.

12. The digital level of claim 1, wherein at least a portion of the front surface or the first side surface separates the first light opening from the fifth light opening.

13. A digital angle gauge comprising:
a housing body, comprising:
a first surface having a first light opening;
a second surface, opposing the first surface, having a second light opening;
a third surface, adjacent the first surface and the second surface, having a third light opening;
an orientation sensor configured to measure an orientation of the housing body with respect to gravity;
a light source, wherein the light source emits light based on the measured orientation of the housing body; and
a light guide, disposed in the housing body, directing the light from light source to the first light opening, the second light opening, and the third light opening.

14. The digital level of claim 13, wherein, the first surface has a fourth light opening, the second surface has a fifth light opening, and the third surface has a sixth light opening, the digital level further comprising:
a second light source, wherein the second light source emits light based on the measured orientation of the housing body; and
a second light guide, disposed in the housing body, directing the light from second light source to the fourth light opening, the fifth light opening, and the sixth light opening.

15. The digital level of claim 13, further comprising:
a processor configured to determine, based on the orientation sensors measurement, a deviation of the digital level from a target orientation;
wherein the light source emits the light based on determining that the deviation of the digital level from the target orientation is less than 0.1 degrees.

16. The digital level of claim 13, wherein the first light guide is of unitary construction.

17. A digital angle gauge comprising:
a housing body, comprising:
a front surface having a first light opening;
a rear surface, opposing the first surface, having a second light opening;
a corner surface, adjacent the front surface and the rear surface, having a third light opening; and
a base surface;
an orientation sensor configured to measure an orientation of the base surface with respect to gravity;
a light source, wherein the light source emits light based on the measured orientation of the base surface; and
a light guide, disposed in the housing body, directing the light from the light source to the first light opening, the second light opening, and the third light opening.

18. The digital level of claim 13, wherein, the front surface has a fourth light opening, the rear surface has a fifth light opening, and the corner surface has a sixth light opening, the digital level further comprising:
a second light source, wherein the second light source emits light based on the measured orientation of the base surface; and
a second light guide, disposed in the housing body, directing the light from second light source to the fourth light opening, the fifth light opening, and the sixth light opening.

19. The digital level of claim 17, further comprising:
a processor configured to determine, based on the orientation sensors measurement, a deviation of the digital level from a target orientation;
wherein the light source emits the light based on determining that the deviation of the digital level from the target orientation is less than 0.1 degrees.

20. The digital level of claim 17, wherein the first light guide is of unitary construction.
